(19) United States
(12) Patent Application Publication
(10) Pub. No.: US 2011/0147682 A1
(43) Pub. Date: Jun. 23, 2011

(54) MAGNESIUM HYDROXIDE

(75) Inventors: Richard Bown, Cornwall (GB); Jeremy John Hooper, Cornwall (GB); Andrew Mark Riley, Cornwall (GB); David Robert Skuse, Cornwall (GB)

(73) Assignee: Imerys Minerals Limited, Par Cornwall (GB)

(21) Appl. No.: 13/003,259

(22) PCT Filed: Jul. 10, 2009
(86) PCT No.: PCT/GB09/50822

§ 371 Date: Feb. 25, 2011

(30) Foreign Application Priority Data
Jul. 10, 2008 (GB) 0812714.4

(51) Int. Cl. C09K 21/02; C01F 5/16; C08K 3/22

(52) U.S. Cl. 252/601; 423/175; 423/177; 524/436

(57) ABSTRACT

A method of making magnesium hydroxide may include calcining a mineral source of magnesium carbonate to form magnesium oxide, and slaking the magnesium oxide in water. When the mineral source of magnesium carbonate further includes a mineral source of calcium carbonate, the calcination may be carried out such that less than about 20 wt % calcium oxide is formed following calcining and prior to slaking in water.

### FIELD OF THE INVENTION

The present invention relates to methods for making magnesium hydroxide (Mg(OH)₂) and uses of said magnesium hydroxide, particularly in articles such as cables as a flame retardant.

### BACKGROUND OF THE INVENTION

Magnesium hydroxide is widely used as a flame retardant. However, natural magnesium hydroxide (brucite) deposits are scarce and often contaminated by fibrous minerals, some of which present a serious health hazard such as asbestos. Current synthetic versions of magnesium hydroxide tend to be costly, hence there is a continued need for alternative, cost effective methods for making magnesium hydroxide which is suitable for use as a flame retardant.

### BRIEF DESCRIPTION OF THE INVENTION

According to a first aspect of the present invention, there is provided a method of making magnesium hydroxide comprising:

calcining a mineral source of magnesium carbonate to form magnesium oxide; and
slaking the magnesium oxide in water;
provided that when the mineral source of magnesium carbonate further comprises a mineral source of calcium carbonate, the calcination is carried out such that less than about 20 wt % calcium oxide is formed prior to slaking in water.

Suitable mineral sources of magnesium carbonate include dolomite, magnesite, hydromagnesite and huntite. Dolomite is calcium magnesium carbonate (CaMg(CO₃)₂) and magnesite is MgCO₃. Hydromagnesite has the formula Mg₅(CO₃)₄(OH)₂.4H₂O and huntite has the formula CaMg₃(CO₃)₄.

As such, the present invention provides a method of making magnesium hydroxide comprising:

calcining magnesite or hydromagnesite to form magnesium oxide; and
slaking the magnesium oxide in water.

The present invention also provides a method of making magnesium hydroxide comprising:

calcining dolomite or huntite to form magnesium oxide; and
slaking the magnesium oxide in water;
and wherein the calcination is carried out such that less than about 20 wt % calcium oxide is formed prior to slaking in water.

Following slaking, the magnesium hydroxide may be separated from the water and dried.

According to a further aspect of the present invention, the magnesium hydroxide made according to the above aspects of the present invention may be combined with one or more other particulate inorganic materials to form a particulate filler material suitable for mixing with a polymer to form a filled polymer.

According to a further aspect of the present invention, the process of the earlier aspects of the invention may comprise further mixing the magnesium hydroxide, optionally with one or more other particulate inorganic materials, with a polymer to form a filled polymer.

According to a further aspect of the present invention, the filled polymer may be formed into an article. Suitable articles include a sheath, coating or housing for an electrical product.

According to yet a further aspect of the present invention, the process of the earlier aspects of the invention may comprise further mixing the magnesium hydroxide, optionally with one or more other particulate inorganic materials, with materials other than polymers, where flame retardancy is desirable, and subsequently formed into articles such as flooring, countertops and plasterboard. Plasterboard may also be referred to as wallboard.

In those aspects of the invention wherein less than about 20 wt % calcium oxide is formed, this is based on the total weight of solids present following calcination. For example less than about 15 wt % calcium oxide is formed; for example less than about 10 wt % calcium oxide is formed. Preferably, substantially no calcium oxide is formed following calcination and prior to slaking in water. For example, about or less than 5 wt % of calcium oxide following calcination is present, preferably less than about 4 wt %, for example less than about 3 wt %, for example less than 2 wt % or less than about 1 wt % based on the total solids present following calcination. These amounts can be determined by analysing the amount of calcium hydroxide in the slaked product, since during the slaking process any calcium oxide is converted to calcium hydroxide.

A suitable method for the determination of calcium hydroxide in the slaked product utilises simultaneous differential scanning calorimetry and thermogravimetric analysis (DSC/TGA). An example of this type of instrument is the STA 409 EP manufactured by the Netzsch company of Germany.

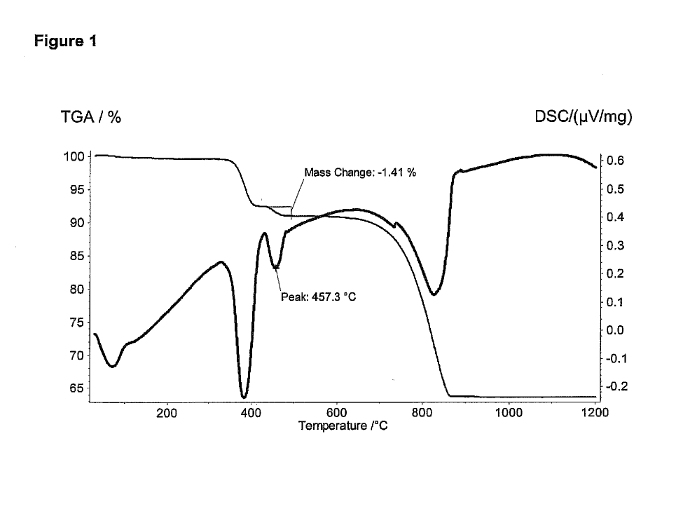

The analysis subjects the sample under test to controlled heating at a rate of 10° C./minute over the range of 25 to 1200° C. in air. An example of the output from the test for a material prepared by calcining and subsequently slaking a sample of dolomite is shown in FIG. 1.

With reference to FIG. 1, the peak in the DSC trace (bold line) at 457.3° C. corresponds to the thermal decomposition of calcium hydroxide with the release of water. The mass loss arising from the decomposition process is calculated from the TGA trace (non-bold) to be 1.41 wt %.

Stoichiometric consideration of the thermal decomposition of calcium hydroxide allows the theoretical mass loss on decomposition to be calculated. Therefore, in the example below, a detected mass loss of 1.41 wt % corresponds to 4.39 wt % calcium oxide present in the calcined sample.

### Ca(OH)₂→CaO+H₂O

74 g→56 g+18 g
100%→75.68%+24.32 wt %.

### DETAILED DESCRIPTION OF THE INVENTION

### Source of Magnesium Carbonate

Suitable sources of magnesium carbonate include mineral ores such as dolomite, magnesite, hydromagnesite and huntite. Dolomite is calcium magnesium carbonate (Ca.Mg(CO₃)₂) and magnesite is MgCO₃. Hydromagnesite is a hydrated magnesium carbonate mineral and has the formula Mg₅(CO₃)₄(OH)₂.4H₂O. Huntite has the formula CaMg₃(CO₃)₄.

Prior to calcining, the mineral ore may be crushed using standard techniques such as a jaw crusher. The crushed ore may then be milled using known techniques to provide a suitable particle size, for example typically less than about 53 μm. Suitable powdered ores may be obtained commercially.

The crushed and optionally milled ore may be beneficiated prior to calcination. For example, the ground particulate ore may be beneficiated in order to improve its brightness and/or to reduce its content of mineral fibres. This may comprise: dispersing the particulate mineral ore in a fluid carrier medium to produce a dispersion; introducing the dispersion into a magnetic field of sufficient field strength to magnetise ferric components of the particulate ore; removing the dispersion from the magnetic field and placing the dispersion in sufficiently close proximity to a magnetic or magnetisable material that the said ferric components of the dispersion are concentrated in the vicinity of the magnetic or magnetisable material; and thereafter separating the said concentrated ferric components from the remainder of the dispersion.

The fluid carrier may be a gas, liquid or flowable solid. An aqueous liquid dispersion is preferred. Suitable dispersing agents may be used if desired, as described above. The magnetic field may be produced by any suitable means. For example, the magnetic field may be produced by an electromagnet, for example a super-conducting magnet. The magnetic field may have a field strength of greater than about 1 Tesla, for example greater than about 2 Tesla, for example greater than about 3 Tesla, for example greater than about 4 Tesla, for example less than about 7 Tesla. Preferably, the magnetic field strength is about 5 Tesla. The magnetic field is of sufficient strength to magnetise magnetisable particles in the dispersion. The magnetisation effect may be of permanent or temporary effect.

The dispersed particulate ore may be static in the magnetic field or may be passed through the magnetic field in a flow. Where a flow system is used, the flow may take place at any suitable rate, and in any suitable way. For example, the dispersion may be passed through the magnetic field at a flow rate of greater than about 10 ml s⁻¹, for example greater than about 15 ml s⁻¹, for example greater than about 20 ml s⁻¹, for example about 25 ml s⁻¹.

The magnetic or magnetisable material may suitably be a ferromagnetic material of any suitable type and in any suitable configuration. For example, the ferromagnetic material may comprise iron, nickel, cobalt or any combination thereof. For example, the ferromagnetic material may be an alloy comprising iron, nickel, cobalt or any combination thereof. The alloy may also comprise other materials, for example carbon. The ferromagnetic material may preferably be formed into any suitable arrangement for contacting with the magnetised dispersion such that the magnetised particles in the dispersion adhere magnetically to the ferromagnetic material. Arrangements which result in a large contact surface area between the dispersion and the ferromagnetic material are therefore particularly favoured. For example, the ferromagnetic material may be in the form of a sieve or mesh or a plurality of sieves and/or meshes. For example, a packed bed may be used comprising particles which comprise a ferromagnetic material, for example particles which are coated with a ferromagnetic material, for example particles which consist essentially of a ferromagnetic material. For example, the ferromagnetic material may be disposed as elongate elements, whose length may be substantially greater than their greatest transverse dimension. The elongate elements may be in an ordered arrangement, for example woven, coiled and/or aligned, or a disordered arrangement, for example entangled and/or matted.

The step of placing the dispersion in sufficiently close proximity to a magnetic or magnetisable material that the said ferric components of the dispersion are concentrated in the vicinity of the magnetic or magnetisable material may be carried out in a static or moving arrangement. The moving arrangement involves relative movement of the dispersion and the magnetic or magnetisable material, although it is not necessary that both are individually moving. It is preferred that the dispersion is moving and the magnetic or magnetisable material is static. It is preferred that the dispersion is in direct contact with the magnetic or magnetisable material in a container or apparatus.

After the ferric components of the dispersion have been concentrated as described above, the ferric components are separated from the remainder of the dispersion. In the preferred arrangement described above, the ferric-depleted dispersion flows on and away from the ferric components adhered to the magnetic or magnetisable (e.g. ferromagnetic) material.

The ferric components may subsequently be removed from the ferromagnetic material by any suitable means. The magnetised particles may be removed by mechanical agitation, or by thermal treatment or by contacting the ferromagnetic material to which the magnetised particles have adhered with a suitable liquid wash, for example water. Preferably, the magnetised particles are magnetised temporarily such that they adhere to the ferromagnetic material during the contacting of the dispersion with the ferromagnetic material but become disadhered easily after the contacting has been completed.

The ferromagnetic material may be disposed in any suitable vessel. The vessel may, for example, itself be made of a ferromagnetic material. The vessel may be provided with inlets and outlets and appropriate valves and control mechanisms as may be required to facilitate the beneficiation process. For example, the vessel may have an inlet and an outlet. The inlet and/or the outlet may be provided with a valve or other means for controlling the flow rate of material through the vessel. The valve(s) or other means may be adapted to be controlled remotely, for example by electronic or computer control equipment.

Other beneficiation methods suitable for improving brightness include one or more of washing, reductive bleaching and oxidative bleaching.

### Calcination

The mineral source of magnesium carbonate may be calcined using known calcining equipment and techniques. When the mineral source of magnesium carbonate also comprises a mineral source of calcium carbonate, which may be present as calcium magnesium carbonate, for example dolomite, then the calcination process is carried out such that preferably the decomposition of calcium carbonate is minimised and no or substantially no calcium oxide is formed. Though, preferably no calcium oxide will be formed, small amounts may be produced. The total amount of calcium oxide formed may be about or less than 5 wt % of the total solid calcined products and preferably less than about 4 wt %, more preferably less than about 2 wt %. This controlled calcination may be referred to as partial calcination and may be represented as shown in equation 1 below. The first step shows the calcination process and the second step shows the slaking step on addition of water wherein the magnesium oxide is converted into magnesium hydroxide:

Ca.Mg(CO₃)₂→MgO+CaCO₃+CO₂→Mg(OH)₂+CaCO₃ (1).

In order that the calcium carbonate is not converted to calcium oxide during the calcining process, or only minimal amounts are present, the calcination is typically performed at less than 900° C., for example about 850° C. The precise temperatures may be chosen with reference to the thermal analysis of the dolomite using, for example, Differential Scanning calorimetry (DSC) or Thermal Gravimetric Analysis (TGA). Such an analysis indicates if the calcium carbonate is decomposing to form calcium oxide.

When the mineral source of magnesium carbonate consists of or consists essentially of only magnesium carbonate, for example magnesite, then the calcination step may suitably be carried out at about 800° C. The full calcination process is shown in equation (2) below, including the slaking step wherein the magnesium oxide is converted to magnesium hydroxide (hydrolysis):

MgCO₃→MgO+CO₂→Mg(OH)₂ (2).

Prior to calcination, the ore may be milled to prevent the formation of aggregates. The milled mineral ore may then be loaded into refractory trays and fed into a suitable furnace. Suitable calciners include rotary calciners, multi-hearth calciners, and fluidised bed calciners. The preferred temperature for calcination as determined from the DSC/TGA analysis may be used as a suitable guide for how long and at what temperature the mineral ore should be calcined. The residence time in the calciner is sufficient to allow for calcination of the magnesium carbonate without affecting or only minimally affecting the degree to which any calcium carbonate present is converted to calcium oxide. Typically, the residence time in the calciner at the appropriate temperature is of the order of around 1 hour.

### Slaking

After the calcination is complete, the calcined product may optionally be dry-milled using, for example, a hammer mill or a ball mill. The milling is carried out such that the particle size is typically less than about 53 μm. During this optional dry milling process any exposure to moisture should be minimised.

The calcined or partially calcined mineral source of magnesium carbonate is slaked by contact with water. Prior to slaking, any exposure of the calcined product to moisture should preferably be minimised. The product of slaking is magnesium hydroxide (Mg(OH)₂), sometimes referred to as MDH (magnesium dihydroxide). Preferably, the slaking is carried out in the absence, or substantial absence, of ionic species at levels greater than those normally found in water. For example, the slaking may be carried out in the absence of additional calcium chloride. More particularly, the water may contain less than 5 wt % calcium chloride. However, in order to control the morphology of the crystals of magnesium hydroxide the pH may be varied, for example by introducing ionic species during the slaking process.

In order to control the morphology of the resulting magnesium hydroxide during the slaking process any one or more of the pH, degree of agitation, temperature, the length of time and the amount of solid in suspension may be varied. It is desirable that discrete particles possessing an hexagonal morphology possessing a diameter of about 5 to 10 μm are obtained. Preferred morphologies may be obtained by increasing the time slaking takes place and the temperature at which it takes place. For applications relating to flame retardants, a surface area of about 1 to 10 m²/g is desirable. A suitable technique for measuring surface area is by the absorption of nitrogen gas utilising the Brunauer, Emmett and Teller theory (BET). A suitable commercial laboratory instrument for this analysis is the Gemini apparatus produced by Micomeritics Inc., USA. If the surface area is too high then the present inventors have found it is difficult to effectively incorporate the particulate magnesium hydroxide in a polymer. Typically, the solids content of the dispersion during slaking may be about 10% by weight total solids.

Once the magnesium hydroxide has been formed it may be necessary to separate out any so-called dead-burned or overburned magnesium oxide which has been formed due to over-calcination. This magnesium oxide tends to be coarser than the magnesium hydroxide. This separation may be carried out using a suitable known separating technique such as sieving, centrifugation or sedimentation.

The crystalline Mg(OH)₂ product may be separated from the aqueous suspension by dewatering, pressing or filtering and dried in air.

If appropriate, during the slaking process an iron sequestering agent may be used, such as triethanolamine, in order to remove any iron and increase the brightness of the Mg(OH)₂.

The dried magnesium hydroxide may be milled. Preferably the milling is carried out so that the particles are only deagglomerated.

The laser light scattering measurement method used herein for making particle size measurements is a well known particle size analysis using a CILAS (Compagnie Industrielle des Lasers) 1064 instrument. The CILAS instrument determines the particle size distribution of a sample by passing a laser beam through a dilute suspension of sample particles and measuring the resultant diffraction pattern of the laser beam. The diffraction pattern is then analyzed using mathematical algorithms (Fraunhofer) based on optical theory to calculate the particle size distribution of the sample. The CILAS 1064 instrument was equipped with a wet sampling device and dual laser detection system to allow accurate measurement of very fine particles. The CILAS 1064 instrument normally provides particle size data to two decimal places.

### Uses of the Magnesium Hydroxide

The magnesium hydroxide made according to the present invention is suitable for use as a filler in a variety of applications.

The magnesium hydroxide may optionally be combined with one or more other particulate inorganic materials in order to provide a particulate inorganic filler material suitable for use in a polymeric composition. However, the magnesium hydroxide may be the only material present in the filler material, particularly for use in cables. The filler is preferably provided for use in the form of a substantially dry powder. The one or more other particulate materials may suitably have flame retardant properties and be present with the particulate magnesium hydroxide made according to the present invention in a flame-retardant amount. Preferred such components include ground and precipitated alumina trihydroxide (ATH). Preferably, there is no calcium hydroxide present or it is present in minimal amounts. For example, the amount of calcium hydroxide present may be less than about 5 wt %, for example less than about 2 wt %, for example less than about 1 wt %, based on the total solids in the filler material.

The particulate inorganic filler comprising the magnesium hydroxide may suitably be present in an amount of between about 1% and about 90%, for example between about 5% and about 80%, for example between about 9% and about 60%, by weight of the filled polymer. The filler is preferably present in the polymer in a flame-retarding amount, to provide a flame-retardant polymeric composition suitable, for example, for use as a sheath, coating or housing for an electrical product. The polymer composition may be formed into an article. The article may be a sheath, coating or housing for an electrical product, for example a sheath component of an electrical cable.

The polymeric composition may be formed by mixing the components of the composition, the polymer component being present for the mixing as liquid or particulate solid, and optionally one or more precursors of the polymer.

With regard to those aspects of the invention relating to the formation of a polymer composition, the polymer comprises any natural or synthetic polymer or mixture thereof. The polymer may, for example, be thermoplastic or thermoset. The term “polymer” used herein includes homopolymers and copolymers, blends, as well as crosslinked and/or entangled polymers and elastomers such as natural or synthetic rubbers and mixtures thereof. Specific examples of suitable polymers include, but are not limited to, polyolefins of any density such as polyethylene and polypropylene, polycarbonate, polystyrene, polyester, polyacrylics, acrylonitrile-butadiene-styrene (ABS) copolymer, nylons, polyurethane, ethylene-vinylacetate (EVA) polymers, polyvinyl chloride, ethylene propylene diene monomer (EPDM) and any mixture thereof, whether cross-linked or un-cross-linked.

The term “precursor” as applied to the polymer component will be readily understood by one of ordinary skill in the art. For example, suitable precursors may include one or more of: monomers, cross-linking agents, curing systems comprising cross-linking agents and promoters, or any combination thereof.

The other particulate inorganic material, when present, may, for example, be selected from phosphorus-containing compounds (e.g. organophosphates or phosphorus pentoxide), boron-containing compounds (e.g. boric acid and metal borates such as sodium borate, lithium metaborate, sodium tetraborate or zinc borate), metal salts, metal hydroxides (e.g. gibbsite, ground or precipitated alumina trihydroxide (ATH), other synthetic magnesium hydroxide), metal oxides (e.g. lead dioxide, antimony oxide), hydrates thereof (e.g. sodium tetraborate decahydrate), mineral sources of any of the foregoing whether in native or at least partially refined form, organoclays (e.g. smectite clays such as bentonite, montmorillonoids such as montmorillonite, talc, pyrophilite, hectorite, vermiculite, perlite, saponite and ion-exchanged forms thereof, suitably ion-exchanged forms incorporating cations selected from quaternary ammonium and alkylimidazolium ions), kaolin clays, other non-kaolin clays (for example as described in Chapter 6 of “Clay Colloid Chemistry” by H. van Olphen, (Interscience, 1963); more specifically: one or more of; illites; other kaolinites such as dickite, nacrite and halloysite; chlorites; attapulgite and sepiolite), and any combination thereof, typically boric acid, a metal borate and any combination thereof. Other components include oxy compounds of calcium, magnesium, aluminium and silicon (or derivatives of such compounds), such as silica, silicate and marble. Particulate inorganic materials may be either naturally occurring or synthesised. The particulate inorganic material may be a mineral chosen from, but not limited to, alumina, limestone, bauxite, gypsum, magnesium carbonate, calcium carbonate (ground and/or precipitated), dolomite, diatomite, huntite, magnesite, boehmite, palygorskite, hydrotalcite and laponite.

The filler material or the polymeric composition made according to the present invention may include one or more other optional flame-retardant and/or non-flame-retardant components, preferably selected from conventional organic heat quenchers such as halogenated hydrocarbons (e.g. halogenated carbonate oligomers, halogenated phenyl oxides, halogenated alkylene-bis-phthalidimides and halogenated diglycyl ethers), optionally together with metal oxides (e.g. antimony oxide) and conventional additives for polymers, for example pigments, colorants, anti-degradants, anti-oxidants, impact modifiers (e.g. core-shell graft copolymers), fillers (e.g. talc, mica, wollastonite, glass or a mixture thereof), slip agents (e.g. erucamide, oleamide, linoleamide or steramide), coupling agents (e.g. silane coupling agents), peroxides, antistatic agents, mineral oils, stabilisers, flow enhancers, mould release agents (e.g. metal stearates such as calcium stearate and magnesium stearate), nucleating agents, clarifying agents, and any combination thereof. Such components are suitably used in total amounts between about 1% and about 70% by total weight of the filler component, and more preferably between about 5% and about 50% by weight, e.g. up to about 30% by weight.

A coupling agent, where present, serves to assist binding of the filler particles to the polymer. Suitable coupling agents will be readily apparent to those skilled in the art. Examples include organic silanes or titanates such as vinyltriethoxysilane, tri-(2-methoxyethoxy)vinylsilane, vinyltriacetylsilane, tetraisopropyltitanate, tetra-n-butyl-titanate, and the like. The coupling agent is typically present in an amount of about 0.1% to about 2% by weight, preferably about 1% by weight, based on the weight of the total particulate filler.

Preparation of the Polymeric Compositions of the Present Invention can be accomplished by any suitable mixing method known in the art, as will be readily apparent to one of ordinary skill in the art. Such methods include dry blending of the individual components or precursors thereof and subsequent processing in a conventional manner.

In the case of thermoplastic polymeric compositions, such processing may comprise melt mixing, either directly in an extruder for making an article from the composition, or pre-mixing in a separate mixing apparatus such as a Banbury mixer. Dry blends of the individual components can alternatively be directly injection moulded without pre-melt mixing.

The filler material prepared according to the present invention can, where it includes more than one component, be prepared by mixing intimately together of the components thereof. The said filler material is then suitably dry blended with the polymer and any desired additional components, before processing as described above.

For the preparation of cross-linked or cured polymeric compositions, the blend of uncured components or their precursors will suitably be contacted under suitable conditions of heat, pressure and/or light with an effective amount of any suitable cross-linking agent or curing system, according to the nature and amount of the polymer used, in order to cross-link and/or cure the polymer.

For the preparation of polymeric compositions where the filler material is present in situ at the time of polymerisation, the blend of monomer(s) and any desired other polymer precursors, filler and any other component(s) will preferably be contacted under suitable conditions of heat, pressure and/or light, according to the nature and amount of the monomer(s) used, in order to polymerise the monomer(s) with the filler material and other component(s) in situ.

The polymeric compositions can be processed to form, or to be incorporated in, articles of commerce in any suitable way. Such processing may include compression moulding, injection moulding, gas-assisted injection moulding, calendering, vacuum forming, thermoforming, extrusion, blow moulding, drawing, spinning, film forming, laminating, vulcanizing or any combination thereof. Any suitable apparatus may be used, as will be apparent to one of ordinary skill in this art.

The articles which may be formed from the compositions are many and various. Examples include sheaths for electrical cables, electrical cables coated or sheathed with the polymer composition, and housings and plastics components for electrical appliances (e.g. computers, monitors, printers, photocopiers, keyboards, pagers, telephones, mobile phones, hand-held computers, network interfaces, plenums and televisions). Fire retardant work surfaces, e.g. counter worktops, may also be formed from a flame-retardant polymeric composition according to the present invention. Other articles may be formed from filled non-polymer based compositions. For example, compositions comprising gypsum for use in plasterboard may also be made. Suitable articles comprising rubber include those for use in flooring, for example in transport applications such as railway carriages, seals, hoses.

The particle size fraction of ground magnesium hydroxide useful for fire retardant electrical components may suitably be in the range less than 106 μm and greater than 38 μm (−106 μm+38 μm). The particle size fraction of ground magnesium hydroxide useful for fire retardant counter worktops may suitably be in the range less than 53 μm and greater than 38 μm (−53 μm+34 μm).

### EXAMPLES

The invention will now be described with reference to the following non-limiting examples.

A number of experiments were carried out to evaluate magnesium hydroxide fillers prepared from Imerys dolomite (Calcidol) and a magnesite obtained from a European deposit. The minerals were supplied as milled products wherein the d₅₀ (as measured by CILAS) for the dolomite was 1.8 μm and 81.2 μm for the magnesite. The magnesium hydroxide filler prepared from the dolomite is referred to as Sample A and the magnesium hydroxide filler prepared from the magnesite is referred to as Sample B.

The tensile properties (including elongation) were measured according to British Safety Standard (BSS) 2782 Part III, 320A-F.

The Underwriters Laboratories Standard UL94 flammability test protocol was performed according to ASTM 3801 on test samples of 3 mm thickness (unless otherwise stated), 125 mm length and 12.5 mm width. According to this test protocol, the test samples were clamped in a vertical position. The lower end was positioned 300 mm above a cotton wool pad and ignited with a Bunsen burner blue flame of 20 mm height. The flame was applied for 10 sec and the burning properties were recorded, i.e. the time taken in seconds for the flame to reach the clamp; whether the polymer composition dripped during burning; whether the cotton wool pad was ignited by any dripping polymer; a visual assessment of the nature and strength of any char; “V rating” (a flammability rating according to the test method).

The Limiting Oxygen Index (LOI) test was carried out on test samples of 3 mm thickness, 50 mm length and 6 mm width according to British Standard 2782, Part I, Method 141B: 1986. The test used an oxygen index machine, which measured the minimum concentration of oxygen in a flowing mixture of oxygen and nitrogen that just supported flaming combustion of the burning polymer. The test samples were clamped in a vertical position inside the glass chimney of the machine and ignited and burnt from top downward. The LOI is expressed in terms of this oxygen concentration.

### Example 1

Samples of the milled mineral ores were loaded in refractory trays in a gas kiln made by CGE in Skelmersdale, UK. The correct temperature for calcination was determined from analysing the DSC/TGA analysis of the mineral. For the magnesite and dolomite samples a programmed cycle of 1 hour at about 850° C. was suitable.

400 g of dry calcined feedstock for each sample was added to 4 litres of water at 50° C. in a stirred stainless steel vessel over a period of 30 minutes with the temperature being maintained by electrical heating at 50° C. After this time, the suspension was screened to remove any particles greater than 53 μm. The screened suspension was left to cool and stand for 16 hours (overnight). The clear supernatant liquid was then decanted off and the remaining (now thickened) suspension was vacuum filtered using standard laboratory Buchner filtration apparatus. The resulting filter cake was dried at 80° C. to constant weight using a forced air oven. Post-drying milling was carried out using the laboratory Fritsch P14 pin mill fitted with a 0.12 mm screen.

The products, i.e. fillers resulting from the calcining and slaking experiments, were loaded into a polymer. The polymer selected was Escorene Ultra EVA grade FL00119 which is a co-polymer of vinyl acetate (19%) and ethylene. The relative amounts of constituents in the filed polymer are shown in Table 1 below.

TABLE 1

| Component | phr |
|---|---|
| EVA resin | 100 |
| Filler | 160 |
| Irganox 1010 | 0.5 |
| A1100 | 1.6 |

wherein phr is parts per hundred resin

Irganox 1010 is an antioxidant which is commercially available from CIBA.

A1100 is an aminosilane coupling agent which is commercially available from GE Bayer Silicones.

The compounding was carried out on a model BR Banbury internal mixer (Farrel Ltd, Rochdale, UK). The mixing schedule is set out below. Sufficient compound was used such that the mixture occupied 64% of the volume of the mixing chamber.

| | | Mixer Set | |
|---|---|---|---|
| Temp/° C. | Action | Temp/° C. | Speed/rpm |
| 0 | Add resin + ½ filler | 90 | 50 |
| | then ⅛ filler | | |
| When T ~70° C. | Add ⅛ filler + | 90 | 75-50 |
| | ½ silane + others | | |
| When T ~90° C. | Add ¼ filler + ½ silane | 90 | 75-50 |
| When T ~100° C. | Brush | 90 | 75-50 |
| When T ~120° C. | Dump when temperature | 90 | Varied until |
| | indicator at 105° C. | | T = 105° C. |

The output material from the compounder was supplied to a laboratory twin roll mill, which was heated to 100° C., for sheeting off to the appropriate thickness.

Data in connection with various properties of the magnesium hydroxide fillers, and ethylene vinyl acetate (EVA) compositions incorporating Sample A and Sample B are presented in Tables 2 and 3.

TABLE 2

| | Sample | Sample |
|---|---|---|
| | A | B |
| TGA loss on decomposition* (%) | 8 | 20.4 |
| Temp of main decomposition peak (° C.) | 382 | 417 |
| Fe₂O₃ ppm | 1600 | 1990 |
| Specific gravity (g/cc) | 2.59 | 2.45 |
| Moisture (wt %) | 0.2 | 0.2 |
| Surface area (m²/g) | 39.3 | 27.5 |
| Violet | n/a | 71.5 |
| Yel | n/a | 8.9 |
| CILAS d₅₀**(μm) | 1.94 | 3.1 |
| CILAS d₉₀ (μm) | 4.61 | 21.9 |
| CILAS d₁₀ (μm) | 0.66 | 0.8 |

*TGA is the loss in mass due to the decomposition of Mg(OH)₂ with the release of water which can potentially extinguish fire in a polymeric article.
*The parameter d₅₀ as measured by CILAS is the mean or average particle equivalent spherical diameter (esd), as measured on the CILAS (Compagnie Industrielle de Lasers) 1064 or corresponding instrument, that is to say, the esd at which there are 50% by volume of the particles which have an esd less than the d₅₀ value which is the volume median diameter.

TABLE 3

| Sample | Tensile | | Yield | | Elonga- | |
|---|---|---|---|---|---|---|
| (in EVA) | Strength (MPa) | sd | Force (N) | sd | tion (%) | sd |
| Sample A | 10.7 | 0.1 | 97.0 | 1.0 | 147 | 25 |
| Sample B | 10.3 | 0.0 | 88.0 | 0.5 | 108 | 7 |

wherein sd is the standard deviation.

3 mm thickness samples of EVA comprising Sample A and EVA comprising Sample B were both subjected to a UL94 test. For the EVA sample comprising Sample B, the results indicated a V-0 classification which means there was no dripping and a total burning time of less than 50 seconds with no samples burning greater than 10 seconds per ignition. The Limiting Oxygen Index (LOI) was 30.0, wherein the LOI is the minimum concentration of oxygen in a flowing mixture with nitrogen that will support combustion for greater than 180 seconds or burn greater than 50 mm of the test piece. For Sample A, the LOI was 25.0 and the UL94 test was unclassified. These results indicate the magnesite mineral source provides a more suitable flame retardant material.

### Example 2

A flame retardant MDH filler (Sample C) was prepared by calcining magnesium carbonate (95% pure by X-ray diffraction analysis) at 800° C. and subsequently slaking at 40° C. followed by a simple sedimentation step to give a refined product with a particle size distribution substantially free of particles >20 μm. Physical properties of the filler are compared to a commercially available brucite mineral (Hydrofy G2.5, obtainable from Nuova Sima) in Table 4.

TABLE 4

| | Commercial | Sample |
|---|---|---|
| | Brucite | C |
| TGA loss on decomposition* (%) | 23.2 | 25.4 |
| Surface area (m²/g) | 7.0 | 22.4 |
| CILAS d₅₀** (μm) | 5.7 | 2.5 |
| CILAS d₉₀ (μm) | 24.6 | 7.9 |
| CILAS d₉₉ (μm) | 43.0 | 14.0 |
| MgO (%) | 56.3 | 64.6 |
| CaO (%) | 6.5 | 1.8 |
| Fe₂O₃ (ppm) | 2560 | 2000 |
| Mn (ppm) | 161 | 100 |

Sample C was incorporated into a flame-retardant rubber compound (ethylene propylene diene monomer) suitable for electrical cable insulation as detailed in Table 5. A control compound incorporating the commercially available brucite mineral from Table 4 was also prepared for comparison.

TABLE 5

| | phr |
|---|---|
| EPDM rubber | 70 |
| EVA resin | 30 |
| Flame retardant filler | 185 |
| Dicumyl peroxide (40% active) | 9 |
| Antioxidant (trimethyldihydroquinoline) | 1.1 |
| Magnesium carbonate | 10 |
| Process oil (paraffinic mineral oil) | 5 |

The compounds were mixed on an open two-roll mill. Cross-linked moulded test sheets were prepared under pressure in a heated press at 170° C. for 20 minutes. The results of mechanical and fire tests carried out on the test pieces cut from the test sheets are shown in Table 6. The values in brackets are the standard deviation.

TABLE 6

| | Control | Sample C |
|---|---|---|
| Yield force (N) | 110 (3.0) | 164 (2.0) |
| Tensile strength (MPa) | 11.7 (0.3) | 16.2 (0.2) |
| Elongation at break (%) | 98 (14) | 107 (6) |
| UL94 rating 2 mm thickness | V-0 | V-0 |
| UL94 rating 3 mm thickness | V-0 | V-0 |
| LOI vol % oxygen | 41.0 | 42.5 |

The results presented in Tables 4 to 6 indicate that the MDH filler prepared in accordance with the invention (Sample C) provides an improved flame retardant material when compared with the commercially available brucite mineral.

1-23. (canceled)

24. A method of making magnesium hydroxide comprising:
calcining a mineral source of magnesium carbonate to form magnesium oxide; and
slaking the magnesium oxide in water;
provided that when the mineral source of magnesium carbonate further comprises a mineral source of calcium carbonate, the calcination is carried out such that less than about 20 wt % calcium oxide is formed following calcining and prior to slaking in water.

25. A method according to claim 24, wherein less than about 10 wt % calcium oxide is formed.

26. A method according to claim 25, wherein about or less than 5 wt % calcium oxide is formed.

27. A method according to claim 24, wherein the mineral source of magnesium carbonate is selected from one or more of: dolomite, magnesite, hydromagnesite and huntite.

28. A method according to claim 24, wherein the mineral source of magnesium carbonate is selected from magnesite and/or hydromagnesite.

29. A method according to claim 24, wherein the mineral source of magnesium carbonate is calcined at less than 900° C.

30. A method according to claim 24, wherein the mineral source of magnesium carbonate is calcined at about or greater than 800° C.

31. A method according to claim 24, wherein prior to calcining, the mineral source of magnesium carbonate is beneficiated by one or more of milling, washing, reductive bleaching, oxidative bleaching, magnetisation.

32. A method according to claim 24, wherein following calcination and prior to slaking the calcined source of magnesium carbonate is dry milled.

33. A method according to claim 24, wherein following slaking the magnesium hydroxide and water are separated and the magnesium hydroxide is dried.

34. A method according to claim 33, wherein the magnesium hydroxide is coated with a coupling agent.

35. A method according to claim 33, wherein the magnesium hydroxide is combined with one or more other flame retardant and/or non flame-retardant components.

36. A method according to claim 33, wherein the magnesium hydroxide is combined with one or more other particulate inorganic materials to form a particulate filler material.

37. A method according to claim 33, wherein the magnesium hydroxide is mixed with a polymer to form a filled polymer.

38. A method according to claim 36, wherein the particulate filler material is mixed with a polymer to form a filled polymer.

39. A method according to claim 37, wherein the polymer is selected from polyolefins of any density such as polyethylene and polypropylene, polycarbonate, polystyrene, polyester, acrylonitrile-butadiene-styrene copolymer, nylons, polyurethane, ethylene-vinylacetate (EVA) polymers, polyvinyl chloride, and any mixture thereof, whether cross-linked or un-cross-linked.

40. A method according to claim 39, wherein the polymer is selected from EVA or cross-linked polyethylene.

41. A method according to claim 24, wherein the surface area of the magnesium hydroxide is about 1 to 10 m²/g.

42. A method of making magnesium hydroxide comprising:
calcining a mineral source of magnesium carbonate to form magnesium oxide; and
slaking the magnesium oxide in water;
provided that when the mineral source of magnesium carbonate further comprises a mineral source of calcium carbonate, the calcination is carried out such that less than about 10 wt % calcium oxide is formed following calcining and prior to slaking in water, and
wherein the mineral source of magnesium carbonate is selected from one or more of: dolomite, magnesite, hydromagnesite, and huntite.
